(19) United States
(12) Patent Application Publication
(10) Pub. No.: US 2018/0218254 A1
(43) Pub. Date: Aug. 2, 2018

(54) SOLAR POWER FORECASTING WITH VOLUMETRIC CONVOLUTIONAL NEURAL NETWORK

(71) Applicant: International Business Machines Corporation, Armonk, NY (US)

(72) Inventors: Minwei Feng, YORKTOWN HEIGHTS, NY (US); Tarun Kumar, Mohegan Lake, NY (US); Rui Zhang, Elmsford, NY (US); Wei Zhang, Elmsford, NY (US)

(73) Assignee: International Business Machines Corporation, Armonk, NY (US)

(21) Appl. No.: 15/422,972

(22) Filed: Feb. 2, 2017

(51) Int. Cl. G06N 3/04; G01W 1/10

(52) U.S. Cl. CPC G06N 3/04; G01W 1/10

(57) ABSTRACT

Four-dimensional (4D) weather forecast data is received which includes a plurality of weather features. The 4D weather forecast data is processed using a chain of a plurality of processing blocks of a neural network to derive one or more of the plurality of weather features. Each of the plurality of processing blocks includes a convolutional layer, an activation layer, and a pooling layer. The convolution layer associates at least one filter to a region of the 4D weather forecast data across a plurality of layers in the 4D weather forecast data. A solar power forecast is determined for a predetermined location based upon the one or more derived weather features.

### TECHNICAL FIELD

The present invention relates generally to a method, system, and computer program product for solar power forecasting. More particularly, the present invention relates to a method, system, and computer program product for solar power forecasting with a volumetric convolutional neural network.

### BACKGROUND

Solar energy production is a growing segment of the renewable energy market. However, current solar energy production is a non-dispatchable power resource, meaning that energy production cannot be turned on or off in a relatively short amount of time in order to meet a demand. Other forms of non-dispatchable include wind power and wave energy.

Variability of non-dispatchable renewable energy can pose challenges for electric grid operators due to uncertainty in determining the amount of energy that may be provided by the resource. System operators need to ensure that they have sufficient resources to accommodate significant up or down ramps in renewable generation to maintain system balance.

Traditionally, weather forecast information is used to determine the amount of solar energy production that may be available. However, the weather forecast information is limited to the point-wise information at the location of the solar farm. This weather forecast information may be suitable for sunny days or overcast sky conditions in which the irradiance from the sky is uniform. However, this type of weather forecast information leads to poor performance in the case of partially cloudy conditions in which clouds cover part of the sky in which the clouds are constantly in motion.

Cloud cover is one of the most difficult predictable sources that have a large effect on solar power production. The traditional approach does not account for the fact that solar conditions may change significantly over a short period of time, e.g., an hour. The inability to model cloud cover and the accompanying cloud movement in traditional systems results in an unreliable solar power forecast of the incident irradiance.

Cloud cover is used as an example factor that affects solar power production. Many other factors in weather forecasting are similarly variable and difficult to predict, and have an effect on the forecasting and production of solar power.

### SUMMARY

The illustrative embodiments provide a method, system, and computer program product. An embodiment includes a method that includes receiving four-dimensional (4D) weather forecast data, the 4D weather forecast data including a plurality of weather features. The method further includes processing the 4D weather forecast data using a chain of a plurality of processing blocks of a neural network to derive one or more of the plurality of weather features. Each of the plurality of processing blocks includes a convolutional layer, an activation layer, and a pooling layer. The convolution layer associates at least one filter to a region of the 4D weather forecast data across a plurality of layers in the 4D weather forecast data. The method further includes determining a solar power forecast for a predetermined location based upon the one or more derived weather features.

Another embodiment further includes processing the weather forecast data using a linear layer to derive the one or more derived weather features. In another embodiment, the 4D weather forecast data includes a time sequence of raster weather forecast data. In one embodiment, the weather forecast data includes two dimensional position data, time data, and weather feature data. In another embodiment, the solar power forecast is based, at least in part, on a spatial distribution of cloud coverage and a movement pattern of clouds proximate to the predetermined location.

In another embodiment, for each processing block, the convolutional layer processes the 4D weather forecast data and provides the processed 4D weather forecast data to the activation layer, the activation layer further processing the weather forecast data and providing the processed weather forecast data to the pooling layer. In another embodiment, the pooling layer processes the 4D weather forecast data and provides the processed 4D weather forecast data to a convolutional layer of a next processing block of the neural network.

In one embodiment, the neural network includes a volumetric convolutional neural network.

An embodiment includes a computer usable program product. The computer usable program product includes one or more computer-readable storage devices, and program instructions stored on at least one of the one or more storage devices. The stored program instructions include program instructions to receive four-dimensional (4D) weather forecast data, the 4D weather forecast data including a plurality of weather features. The stored program instructions further include program instructions to process the 4D weather forecast data using a chain of a plurality of processing blocks of a neural network to derive one or more of the plurality of weather features. Each of the plurality of processing blocks including a convolutional layer, an activation layer, and a pooling layer. The convolution layer associates at least one filter to a region of the 4D weather forecast data across a plurality of layers in the 4D weather forecast data. The stored program instructions further include program instructions to determine a solar power forecast for a predetermined location based upon the one or more derived weather features.

An embodiment includes a computer system. The computer system includes one or more processors, one or more computer-readable memories, and one or more computer-readable storage devices, and program instructions store on at least one of the one or more storage devices for execution by at least one of the one or more processors via at least one of the one or more memories. The stored program instructions include program instructions to receive four-dimensional (4D) weather forecast data, the 4D weather forecast data including a plurality of weather features. The stored program instructions further include program instructions to process the 4D weather forecast data using a chain of a plurality of processing blocks of a neural network to derive one or more of the plurality of weather features. Each of the plurality of processing blocks including a convolutional layer, an activation layer, and a pooling layer. The convolution layer associates at least one filter to a region of the 4D weather forecast data across a plurality of layers in the 4D weather forecast data. The stored program instructions further include program instructions to determine a solar power forecast for a predetermined location based upon the one or more derived weather features.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts an example convolution layer process in accordance with an illustrative embodiment;

FIG. 4 depicts a layer diagram of an example volumetric convolutional neural network structure 400 for solar power forecasting;

FIG. 5 depicts a flowchart of an example process for determining 4D weather forecast data in accordance with an illustrative embodiment; and

FIG. 6 depicts a flowchart of an example process for solar power forecasting with a volumetric convolutional neural network.

### DETAILED DESCRIPTION

The illustrative embodiments described herein generally relate to solar power forecasting with a volumetric convolutional neural network. In accordance with one or more embodiments, four-dimensional (4D) weather forecast data is input to a volumetric convolutional neural network in order to calculate a solar power forecast for a particular location having a solar power generating facility such as a solar farm. Volumetric data is four-dimensional data, such as video image data, that further includes depth information. Accordingly, a volumetric convolutional network is a convolutional neural network in which the data to be processed by the convolutional neural network further includes depth information. In one or more embodiments, the depth data includes time data associated with multiple raster images in which each raster image includes weather feature data. In particular embodiments, the 4D weather forecast data includes weather feature data, time data, x position data, and y position data.

An Artificial Neural Network (ANN)—also referred to simply as a neural network—is a computing system made up of a number of simple, highly interconnected processing elements (nodes/filters), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior. A feedforward neural network is an artificial neural network where connections between the units do not form a cycle.

In machine learning, a convolutional neural network (CNN) is a type of feed-forward artificial neural network in which the connectivity pattern between its nodes (neurons/filters) is inspired by the organization of the animal visual cortex, whose individual neurons are arranged to respond to overlapping regions tiling a visual field. Convolutional networks mimic biological processes and are configured as variations of multilayer perceptrons designed to use minimal amounts of preprocessing while processing data, such as digital images.

Convolutional neural networks (CNN) are networks with overlapping “reception fields” performing convolution tasks. A CNN is particularly efficient in recognizing image features, such as by differentiating pixels or pixel regions in a digital image from other pixels or pixel regions in the digital image. Generally, a CNN is designed to recognize images or parts of an image, such as detecting the edges of an object recognized on the image. Computer vision is a field of endeavor where CNNs are commonly used.

A deep neural network (DNN) is an artificial neural network (ANN) with multiple hidden layers of units between the input and output layers. Similar to shallow ANNs, DNNs can model complex non-linear relationships. DNN architectures, e.g., for object detection and parsing, generate compositional models where the object is expressed as a layered composition of image primitives. The extra layers enable composition of features from lower layers, giving the potential of modeling complex data with fewer units than a similarly performing shallow network. DNNs are typically designed as feedforward networks.

In one or more embodiments, the 4D weather forecast data includes two-dimensional position data, time data, and weather feature data which include forecast value data. Weather feature data includes weather forecast products generated from weather data measurements. In one or more embodiments, the weather forecast data is represented as an image raster containing weather forecast data including a plurality of weather forecast features to be mapped in a feature space of the volumetric convolutional neural network. The weather forecast features include the weather forecast data to be processed by the volumetric convolutional neural network, and the feature space is the space within the neural network in which the weather features are mapped to allow processing of the weather forecast data by the neural network. In particular embodiments, the four dimensions of the weather forecast data includes latitude data, longitude data, time series data, and weather feature data in a feature space.

For example, weather features data in the form of temperature forecast data may include a latitude value, a longitude value, a time value, and a temperature measurement value. In one or more embodiments, the 4D weather forecast data may take the form of a sequence of image data in which each image is associated with a particular time of weather forecast measurement and encodes a location (e.g., latitude, longitude) and weather forecast measurement associated with the location.

The use of 4D weather forecast data to forecast solar power provides more accurate forecast than can be obtained by traditional methods. In traditional methods of solar power forecasting, the use of 4D weather forecast data is too computationally complex to be practical. The illustrative embodiments recognize that the use of 4D weather forecast data in a solar power forecast model allows for cloud cover distribution as well as the temporal evolution of cloud movement to be considered to provide a more accurate solar power forecast. However, the use of 4D weather data requires significant processing power in order to calculate an accurate solar power prediction. In accordance with one or more embodiments, a neural network based deep learning is used to calculate a solar power forecast using 4D weather forecasting data. In a particular embodiment, a volumetric convolutional neural network is used to calculate a solar power forecast using the 4D weather data.

In accordance with one or more embodiments, weather data is collected from one or more weather data collecting devices and provided to one or more weather forecasting applications running on one or more servers. In particular embodiments, examples of weather data that may be collected include, but are not limited to, temperature, barometric pressure, humidity, wind speed and direction, and precipitation. In particular embodiments, the weather collecting devices may include weather stations and other sensors. In one or more embodiments, the weather forecasting application processes the collected weather data to calculate 4D weather forecast data including one or more weather features, and stores the weather forecast data in a storage device. In particular embodiments, the 4D weather forecast data may include one or more of the 4D weather forecast data shown in Table 1 below:

TABLE 1

| Column | Type | 3D | Description | Unit |
|---|---|---|---|---|
| U_84 | float | | x-wind speed at 84 | m/s |
| | | | meter | |
| V_84 | float | | y-wind speed at 84 | m/s |
| | | | meter | |
| W_84 | float | | z-wind speed at 84 | m/s |
| | | | meter | |
| RHO84 | float | | air density at 84 | kg/m³ |
| | | | meter | |
| HGT | float | | terrain height | m |
| REFC | float | | Max Reflectivity | dBZ |
| APCP | float | | Accumulated | mm |
| | | | Precipitation | |
| PRATE | float | | Instantaneous | mm/s or |
| | | | Precipitation Rate | kg/m^{2/s} |
| RH | float | | 2m Relative Humidity | % |
| DPT2m | float | | 2m Dewpoint | Kelvin |
| | | | Temperature | |
| SLP | float | | Sea Level Pressure | Pascal |
| CAPE_SFC | float | | Max Convective | J/kg |
| | | | Available Potential | |
| | | | Energy | |
| U10 | float | | x-wind at 10 meter | meter/s |
| V10 | float | | y-wind at 10 meter | m/s |
| T2 | float | | TEMP at 2 M | Kelvin |
| SWDDNI | float | | Shortwave surface | W/m² |
| | | | downward direct | |
| | | | normal irradiance | |
| SWDDIR | float | | Shortwave surface | w/m² |
| | | | downward direct | |
| | | | irradiance | |
| SWDDIF | float | | Shortwave surface | w/m² |
| | | | downward diffuse | |
| | | | irradiance | |
| SWDOWN | float | | DOWNWARD SHORT | w m−2 |
| | | | WAVE FLUX AT | |
| | | | GROUND SURFACE | |
| PSFC | float | | SFC PRESSURE | Pa |
| SFROFF | float | | SURFACE RUNOFF | mm |
| ACSNOW | float | | ACCUMULATED SNOW | kg m−2 |
| SNOWH | float | | PHYSICAL SNOW DEPTH | m |
| COSMO_GUST | float | | cosmo gust | m/s |
| GUST | float | | gust | m/s |
| Heat_Index | float | | temperature | degrees F. |
| K_Index | float | | temperature | degrees |
| | | | | Celsius |
| LPI | float | | Lightening Potential | J/kg |
| | | | Index | |
| NC_GUST | float | | NC gust | dBZ |
| SFC_GUST | float | | Max Reflectivity | m/s |
| SNDENS | float | | | |
| Snowfall_Rate | float | | Snow fall rate | inches/hr |
| TKE_GUST | float | | TKE Gust | m/s |
| VIS | float | | Visibility | m |
| Wind_Chill | float | | Wind Chill | degrees F. |
| | | | temperature | |
| XLAT | float | | Latitude | |
| XLONG | float | | Longitude | |
| U | float | yes | x-wind speed | m/s |
| V | float | yes | y-wind speed | m/s |
| W | float | yes | z-wind speed | m/s |
| LEV | float | yes | height of each z | km |
| | | | level | |
| QTOTAL | float | yes | qtotal at layers | kg kg−1 |
| Reflectivity | float | yes | reflectivity at | dbZ |
| | | | layers | |

In one or more embodiments, a request to calculate a solar power forecast is sent to a neural network application implementing a volumetric convolutional neural network from a client device. In response to receiving the request, the neural network application requests the 4D weather forecast data, receives the 4D weather forecast data from the storage device, and initializes the volumetric convolutional neural network using the received 4D weather forecast data. In one or more embodiments, the volumetric convolutional neural network takes advantage of the fact that the input comprises images and constrains neural network architecture in such a way that to take advantage of the image representation of the data. Unlike a regular neural network, the layers of a convolutional neural network according to an embodiment have neurons arranged in three dimensions including width, height, and depth in which the depth refers to the third dimension of an activation volume, not to the number of layers in the full neural network. The neural network includes mathematical functions called neurons that function to receive one or more inputs and sum them to produce and output. The activation volume represents the portion of the neural network configured to process the input data. The neurons in a layer are connected to a small region of the layer before it, instead of being connected to all of the neurons of the previous layer in a fully-connected manner. In addition, the structure of convolutional neural network results in a final output layer producing an output in which the full image is reduced to a single vector of results arranged along the depth dimension.

Each layer of the convolutional neural network transforms one volume of activations to another through a differentiable function. A differentiable function is a mathematical function whose derivatives exist at each point in its domain. A convolutional layer computes the output of neurons that are connected to local regions in the input, each computing a dot product between their weights and a small region they are connected to in the input volume in which the input volume represents the 4D weather forecast data to be input into the neural network. The convolutional layer's parameters include a set of learnable filters. Every filter is small spatially (along width and height), but extends through the full depth of the input volume. For example, a typical filter on the convolutional layer may have a size 5×5×3 (i.e. 5 pixels' width and height, 3 color channels). During a forward pass, each filter is convolved in a sliding operation across the width and height of the input volume to compute dot products between the entries of the filter and the input at any position. As a result of the convolution, a 2-dimensional activation map is produced that provides the responses of that filter at every spatial position.

Through machine learning, the network of an embodiment learns the filters that activate when they see some type of visual feature such as an edge of some orientation or a blotch of some color on the first layer, or eventually entire honeycomb or wheel-like patterns on higher layers of the network. As a result, an entire set of filters in each convolutional layer (e.g. 12 filters) is produced, and each of them will produce a separate 2-dimensional activation map. wherein the convolutional layer associates a filter to a region of the 4D weather forecast data across a plurality of layers in the 4D weather data. These activation maps are stacked along the depth dimension and produce the output volume. When dealing with high-dimensional inputs such as images, it may be impractical to connect neurons to all neurons in the previous volume. Instead, each neuron is connected to only a local region of the input volume. The spatial extent of this connectivity is a hyperparameter called the receptive field of the neuron (equivalently this is the filter size). The extent of the connectivity along the depth axis is always equal to the depth of the input volume. Accordingly, the connections are local in space (along width and height), but full along the entire depth of the input volume.

An activation layer, such as a rectifier linear unit (RELU) layer, applies an elementwise activation function. An example of an elementwise activation function that may be used by the activation layer includes a max (0, x) function thresholding at zero in which x is the input to a neuron. As a result, negative values are set to zero and positive values remain unchanged. This leaves the size of the volume unchanged. In another particular embodiment, the activation layer may include a Sigmoid layer which applies a sigmoid function to the data values.

A pooling layer (e.g. a max pooling layer) performs a downsampling operation along the spatial dimensions (width, height) resulting in a volume that is smaller than the input volume. The pooling layer functions to progressively reduce the spatial size of representation to reduce the amount of parameters and computation in the network. The pooling layer operates independently on every depth slice of the input and resizes it spatially using a MAX operation. Because the max pooling layer computes a fixed function, it may introduce zero parameters. In a particular example of a pooling operation, a pooling layer with filters of a size 2×2 applies a stride of two downsamples every depth slice in the input by 2 along both width and height, and discarding 75% of the activations. Every MAX operation would in this case be taking a max over 4 numbers (a 2×2 region in some depth slice) with the depth dimension remaining unchanged. Accordingly, the max pooling layer accepts a volume of a particular size and produces a volume a smaller height and weight dimension but having the same depth. The downsampling operation provides for reduced computational requirements.

In one or more embodiments, the volumetric convolutional neural network structure includes a chain of processing blocks in which processing each block includes a convolutional layer, an activation layer, and a max pooling layer. Each of the convolution layers, the activation layer, and the max pooling layer processes a set of time sequences of the 4D weather forecast data to identify one or more weather features of the 4D weather forecast data to be used in the calculation of a solar power forecast. In a particular embodiment, the volumetric convolutional neural network layer includes a chain of five processing blocks, each having a convolutional layer, an activation layer, and a max pooling layer.

In one or more embodiments, the volumetric convolutional neural network includes an input layer to receive the 4D weather forecast data and provide the 4D weather forecast data to the convolution layer of the first processing block of the convolutional neural network. The convolutional layer processes the 4D weather forecast data by performing convolution on 4D weather forecast data and provides convolved data to the activation layer of the first processing block. The activation layer further processes the convolved data received from the convolutional layer by performing an activation function on the convolved data and provides activated data to the max pooling layer of the first processing block. The max pooling layer then still further processes the data by performing a downsampling operation on the activated data and provides the downsampled data to the convolutional layer of the next processing block.

In one or more embodiments, the convolutional neural network is trained on four dimensional data (e.g., latitude, longitude, time series data, and weather features in a feature space) to determine a model in which the model includes a chain of processing blocks. Each processing block includes a convolutional layer, an activation layer, and a max pooling layer.

The processing continues until the data has been processed by all of the layers within each processing block of the chain of processing blocks. In a particular embodiment, the number of processing blocks to be used in the chain of processing blocks is determined by checking a validation error using a number of different blocks and choosing the number of blocks that yields the best validation error. The max pooling layer of the final processing block provides processed data to a linear layer.

The linear layer provides an output of a single vector of outputs arranged along the depth dimension. The output includes one or more weather features derived from the 4D weather forecast input, e.g., the cloud cover mobility in the 4D weather forecast, which is to be used to compute a solar power forecast for a predetermined location. A solar power forecast is then computed using the derived weather features. In one or more particular embodiments, the solar power forecast is based, at least in part, on a spatial distribution of cloud coverage and a movement pattern of the clouds near or around a particular location such as solar farm. Feature extraction from 4D weather data and the use thereof in solar power forecasting in this manner is unavailable in the presently used solar power forecasting methods.

The illustrative embodiments are described with respect to certain types of solar power forecasting, neural networks, transmissions, validations, responses, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

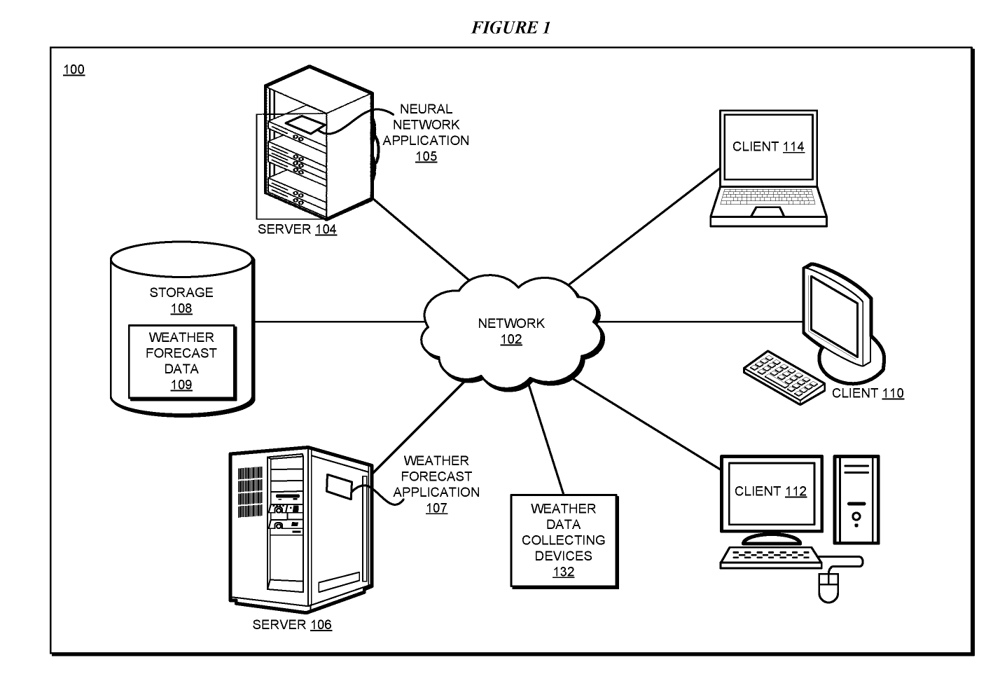

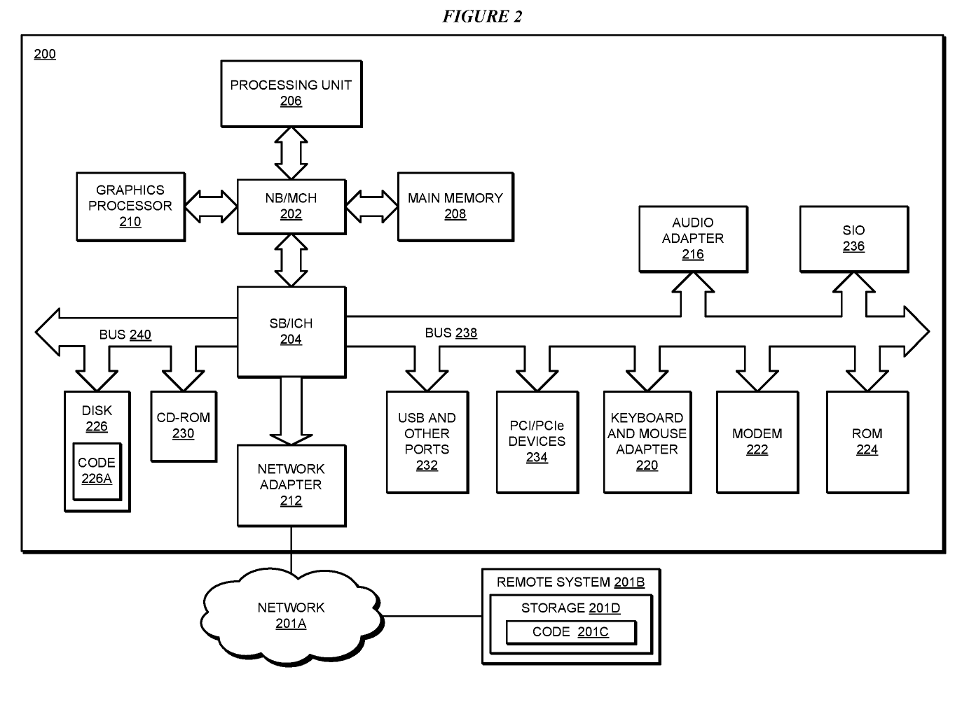

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. In one or more embodiments, storage 108 may be configured to store weather forecast data 109. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Weather data collecting devices 132 are examples of a device described herein. For example, weather collecting devices 132 can take the form of a weather station or any other suitable device for collecting weather data measurements. Any software application described as executing in another data processing system in FIG. 1 can be configured to execute in weather collecting devices 132 in a similar manner. Any data or information stored or produced in another data processing system in FIG. 1 can be configured to be stored or produced in weather collecting device 132 in a similar manner.

Neural network application 105 of server 104 implements an embodiment of a neural network, such as a volumetric convolutional neural network, described herein. Weather forecast application 107 implements the generation of 4D weather forecast data 109 using one or more weather forecasting processes as described herein with respect to various embodiments.

Servers 104 and 106, storage unit 108, and clients 110, 112, and 114, and weather data collecting devices 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as applications 105 and 107 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

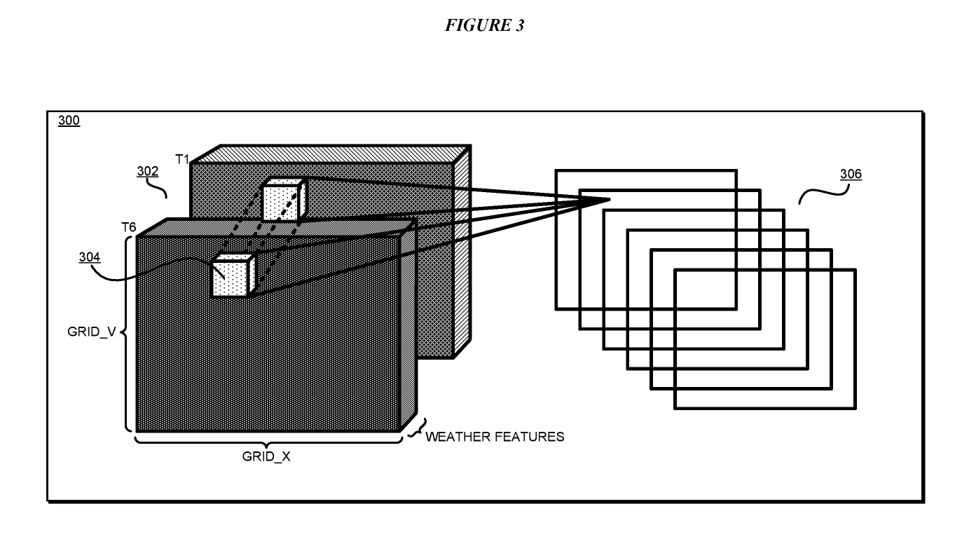

With respect to FIG. 3, this figure depicts an example convolution layer process 300 in accordance with an illustrative embodiment. 4D weather forecast data 302 includes a series of raster images spanning over a time T1 to T6 in which each raster image includes a horizontal grid, grid x, a vertical grid, grid y, and weather forecast data including one or more weather features. The convolutional layer process 300 computes a dot product between weights of neurons and a local region 304 connected to the 4D weather forecast data input to produce one or more 2-dimensional activation maps 306 is produced that provides the output of the convolution at every spatial position.

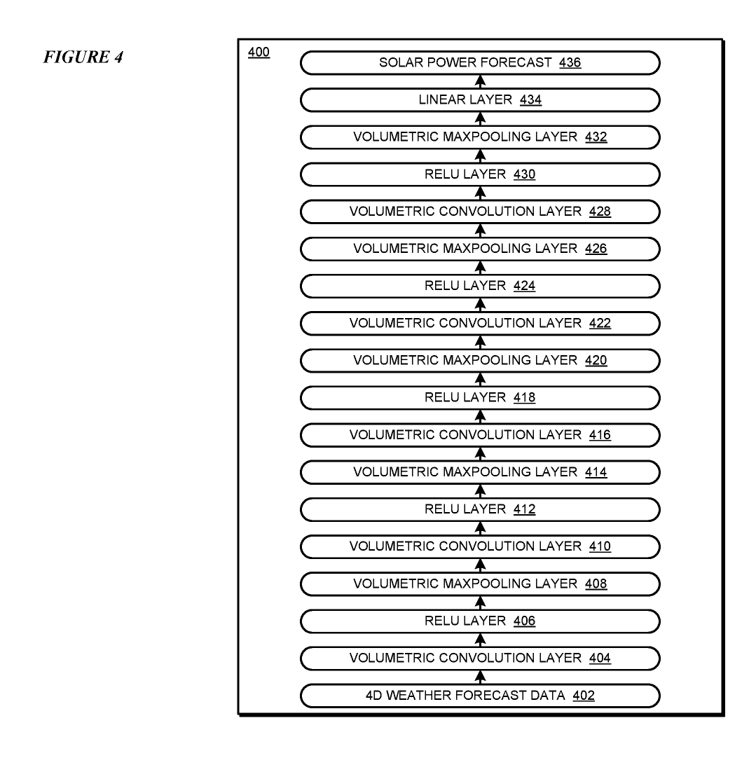

With respect to FIG. 4, this figure depicts a layer diagram of an example volumetric convolutional neural network structure 400 for solar power forecasting. Volumetric convolutional neural network structure 400 includes a chain of five processing blocks in which processing each block includes a convolutional layer, an activation layer, and a max pooling layer. Block 1 spans layers 404, 406, and 408; block 2 spans layers 410, 412, and 414; block 3 spans layers 416, 418, and 420; block 4 spans layers 422, 424, and 426; and block 5 spans layers 428, 430, and 432.

In the illustrated embodiment, an input layer 402 provides 4D weather forecast data to a first volumetric convolution layer 404 of a first processing block. First volumetric convolution layer 404 calculates one or more convolution operations on the 4D weather forecast data as described herein and provides the output to a first activation (RELU) layer 406. First activation (RELU) layer 406 calculates one or more activation functions on the output received from first volumetric convolution layer 404 and provides the output to a first volumetric max pooling layer 408 that performs a downsampling operation on the data received from first activation (RELU) layer 406 to produce output data of a reduced dimension. The output generated by first volumetric max pooling layer 408 is provided to a second volumetric convolution layer 410 of a second processing block.

Second volumetric convolution layer 410 calculates one or more convolution operations on the data received from first volumetric max pooling layer 408 and provides the output to a second activation (RELU) layer 408. Second activation (RELU) layer 412 calculates one or more activation functions on the output received from second volumetric convolution layer 410 and provides the output to a second volumetric max pooling layer 414 that performs a downsampling operation on the data received from second activation (RELU) layer 412 to produce output data of a reduced dimension. The output generated by second volumetric max pooling layer 414 is provided to a third volumetric convolution layer 416 of a third processing block

Third volumetric convolution layer 416 calculates one or more convolution operations on the data received from second volumetric max pooling layer 414 and provides the output to a third activation (RELU) layer 418. Third activation (RELU) layer 418 calculates one or more activation functions on the output received from third volumetric convolution layer 416 and provides the output to a third volumetric max pooling layer 420 that performs a downsampling operation on the data received from third activation (RELU) layer 418 to produce output data of a reduced dimension. The output generated by third volumetric max pooling layer 420 is provided to a fourth volumetric convolution layer 422 of a fourth processing block.

Fourth volumetric convolution layer 422 calculates one or more convolution operations on the data received from third volumetric max pooling layer 420 and provides the output to a fourth activation (RELU) layer 424. Fourth activation (RELU) layer 424 calculates one or more activation functions on the output received from fourth volumetric convolution layer 422 and provides the output to a fourth volumetric max pooling layer 426 that performs a downsampling operation on the data received from fourth activation (RELU) layer 424 to produce output data of a reduced dimension. The output generated by fourth volumetric max pooling layer 426 is provided to a fifth volumetric convolution layer 428 of a fifth processing block

Fifth volumetric convolution layer 428 calculates one or more convolution operations on the data received from fourth volumetric max pooling layer 426 and provides the output to a fifth activation (RELU) layer 430. Fifth activation (RELU) layer 430 calculates one or more activation functions on the output received from fifth volumetric convolution layer 428 and provides the output to a fifth volumetric max pooling layer 432 that performs a downsampling operation on the data received from fifth activation (RELU) layer 430 to produce output data of a reduced dimension. The output generated by fifth volumetric max pooling layer 432 is provided to a linear layer 434. [QUESTION FOR INVENTORS: It appears that each block essentially performs the same processing but on progressively changing inputs. Could we specify what is progressively changing as each block is processed?]

Linear layer 434 provides an output of one or more weather features derived from the 4D weather forecast input to be used to compute a solar power forecast for a predetermined location. In layer 436, a solar power forecast is computed using the derived weather features. In one or more particular embodiments, the solar power forecast is based, at least in part, on a spatial distribution of cloud coverage and a movement pattern of the clouds near or around a particular location such as solar farm.

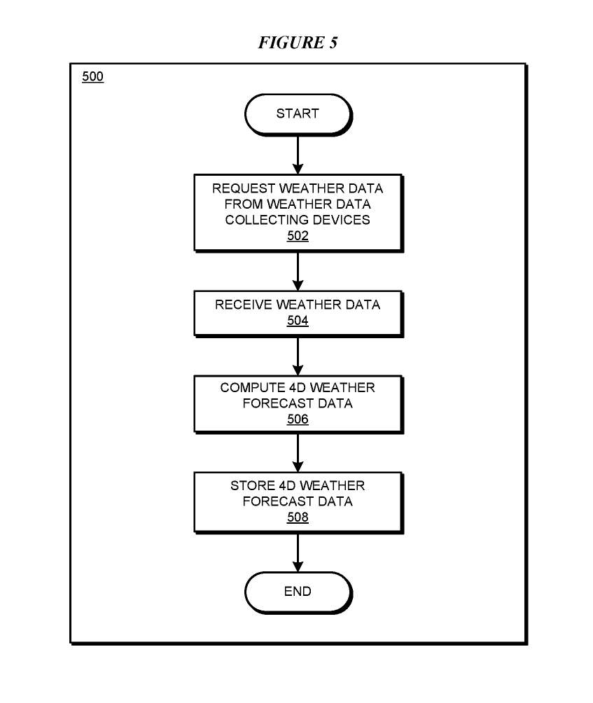

With reference to FIG. 5, this figure depicts a flowchart of an example process 500 for determining 4D weather forecast data in accordance with an illustrative embodiment. In one or more embodiments, process 500 can be implemented in weather forecast application 107 or neural network application 105 of FIG. 1. In block 502, weather forecast application 107 of server 106 requests weather data from one or more weather data collecting devices 132. In particular embodiments, weather data collecting devices 132 may include a weather station including one or more weather data sensors.

In block 504, weather forecast application 107 receives the requested weather data. In block 506, weather forecast application 107 computes 4D weather forecast data based upon the received weather data. In block 508, weather forecast application 107 stores weather forecast data 109 in storage device 108. Process 500 is ended thereafter.

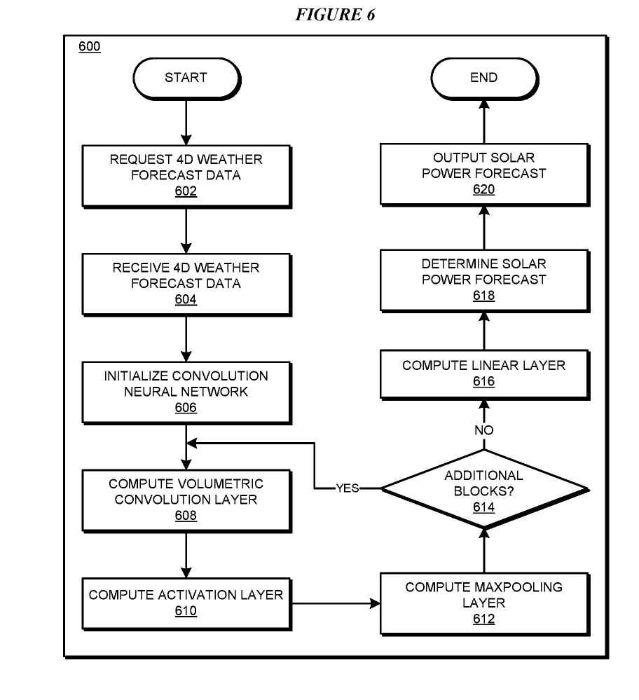

With reference to FIG. 6, this figure depicts a flowchart of an example process 600 for solar power forecasting with a volumetric convolutional neural network. In one or more embodiments, process 600 can be implemented in neural network application 105 or weather forecast application 107 of FIG. 1. In block 602, neural network application 105 requests 4D weather forecast data 109 from storage device 108. In block 604, neural network application 105 receives the 4D weather forecast data.

In block 606, neural network application 105 initializes a volumetric convolutional neural network and provides the 4D weather forecast data to the volumetric convolutional neural network. In 608, in a first processing block, the volumetric convolutional neural network computes a volumetric convolutional layer operation on the input data as described herein. In block 610, the volumetric convolutional neural network computes an activation layer operation as describe herein on the data processed by the volumetric convolution layer in block 608. In block 612, the volumetric convolutional neural network computes a max pooling layer operation on the data processed by the activation layer in block 610. In 614, the neural network application 105 determines whether there are any remaining processing blocks within the volumetric convolutional neural network structure. If it is determined that there are remaining processing blocks, process 600 returns to block 608 in which the operations of blocks 608, 610, and 612 are repeated upon the data processed in the previous processing block.

If it is determined that there are no remaining processing blocks within the volumetric convolutional neural network structure, process 600 continues to block 610. In block 616, the volumetric neural network computers a linear layer operation on the data output from the previous max pooling layer. The linear layer operation provides an output of one or more weather features derived from the 4D weather forecast input to be used to compute a solar power forecast for a predetermined location. In 618, neural network application 105 computes and/or determines a solar power forecast for the predetermined location based upon the derived weather features. In one or more particular embodiments, the solar power forecast is based, at least in part, on a spatial distribution of cloud coverage and a movement pattern of the clouds proximate to a particular location such as solar farm. In 620, neural network application 105 outputs the solar power forecast. Process 500 is ended thereafter.

Thus, a computer implemented method, system or apparatus, and computer program product are provided in the illustrative embodiments for solar power forecasting with a volumetric convolutional neural network and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving four-dimensional (4D) weather forecast data, the weather forecast data including a plurality of weather features;
processing the 4D weather forecast data using a chain of a plurality of processing blocks of a neural network to derive one or more of the plurality of weather features, each of the plurality of processing blocks including a convolutional layer, an activation layer, and a pooling layer, wherein the convolution layer associates at least one filter to a region of the 4D weather forecast data across a plurality of layers in the 4D weather forecast data; and
determining a solar power forecast for a predetermined location based upon the one or more derived weather features.

2. The method of claim 1, further comprising processing the 4D weather forecast data using a linear layer to derive the one or more derived weather features.

3. The method of claim 1, wherein the 4D weather forecast data includes a time sequence of raster weather forecast data.

4. The method of claim 1, wherein the 4D weather forecast data includes two dimensional position data, time data, and weather feature data.

5. The method of claim 1, wherein the solar power forecast is based, at least in part, on a spatial distribution of cloud coverage and a movement pattern of clouds proximate to the predetermined location.

6. The method of claim 1, wherein, for each processing block, the convolutional layer processes the 4D weather forecast data and provides the processed 4D weather forecast data to the activation layer, the activation layer further processing the weather forecast data and providing the processed weather forecast data to the pooling layer.

7. The method of claim 6, wherein the pooling layer processes the 4D weather forecast data and provides the processed 4D weather forecast data to a convolutional layer of a next processing block of the neural network.

8. The method of claim 1, wherein the neural network includes a volumetric convolutional neural network.

9. A computer usable program product comprising one or more computer-readable storage devices, and program instructions stored on at least one of the one or more storage devices, the stored program instructions comprising:
program instructions to receive four-dimensional (4D) weather forecast data, the 4D weather forecast data including a plurality of weather features;
program instructions to process the 4D weather forecast data using a chain of a plurality of processing blocks of a neural network to derive one or more of the plurality of weather features, each of the plurality of processing blocks including a convolutional layer, an activation layer, and a pooling layer, wherein the convolution layer associates at least one filter to a region of the 4D weather forecast data across a plurality of layers in the 4D weather forecast data; and
program instructions to determine a solar power forecast for a predetermined location based upon the one or more derived weather features.

10. The computer usable program product of claim 9, further comprising program instructions to process the 4D weather forecast data using a linear layer to derive the one or more derived weather features.

11. The computer usable program product of claim 9, wherein the 4D weather forecast data includes a time sequence of raster weather forecast data.

12. The computer usable program product of claim 9, wherein the 4D weather forecast data includes two dimensional position data, time data, and weather feature data.

13. The computer usable program product of claim 9, wherein the solar power forecast is based, at least in part, on a spatial distribution of cloud coverage and a movement pattern of clouds proximate to the predetermined location.

14. The computer usable program product of claim 9, wherein, for each processing block, the convolutional layer processes the 4D weather forecast data and provides the processed 4D weather forecast data to the activation layer, the activation layer further processing the 4D weather forecast data and providing the processed 4D weather forecast data to the pooling layer.

15. The computer usable program product of claim 14, wherein the pooling layer processes the 4D weather forecast data and provides the processed weather forecast data to a convolutional layer of a next processing block of the neural network.

16. The computer usable program product of claim 9, wherein the computer usable code is stored in a computer readable storage device in a data processing system, and wherein the computer usable code is transferred over a network from a remote data processing system.

17. The computer usable program product of claim 9, wherein the computer usable code is stored in a computer readable storage device in a server data processing system, and wherein the computer usable code is downloaded over a network to a remote data processing system for use in a computer readable storage device associated with the remote data processing system.

18. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to receive four-dimensional (4D) weather forecast data, the 4D weather forecast data including a plurality of weather features;
program instructions to process the 4D weather forecast data using a chain of a plurality of processing blocks of a neural network to derive one or more of the plurality of weather features, each of the plurality of processing blocks including a convolutional layer, an activation layer, and a pooling layer, wherein the convolution layer associates at least one filter to a region of the 4D weather forecast data across a plurality of layers in the 4D weather forecast data; and
program instructions to determine a solar power forecast for a predetermined location based upon the one or more derived weather features.

19. The computer system of claim 18, the stored program instructions further comprising program instructions to process the 4D weather forecast data using a linear layer to derive the one or more derived weather features.

20. The computer system of claim 18, wherein, for each processing block, the convolutional layer processes the 4D weather forecast data and provides the processed 4D weather forecast data to the activation layer, the activation layer further processing the 4D weather forecast data and providing the processed 4D weather forecast data to the pooling layer.
